(19) United States
(12) Patent Application Publication
(10) Pub. No.: US 2021/0325207 A1
(43) Pub. Date: Oct. 21, 2021

(54) MAP UPDATING SYSTEM AND METHOD FOR AUTONOMOUS DRIVING

(71) Applicant: UISEE TECHNOLOGIES (BEIJING) LTD., Beijing (CN)

(72) Inventors: Wei LIN, Beijing (CN); Wei FENG, Beijing (CN); Xiaotong LIU, Beijing (CN); Yu ZHANG, Beijing (CN); Lei SHI, Beijing (CN)

(73) Assignee: UISEE TECHNOLOGIES (BEIJING) LTD., Beijing (CN)

(21) Appl. No.: 17/359,565

(22) Filed: Jun. 27, 2021

Related U.S. Application Data
(63) Continuation of application No. PCT/CN2018/124448, filed on Dec. 27, 2018.

(51) Int. Cl. G01C 21/00; G01C 21/32

(52) U.S. Cl. CPC G01C 21/3811; G01C 21/3848; G01C 21/32

(57) ABSTRACT

The present disclosure provides a map updating method, system and a readable storage medium for autonomous driving. The method may include: a vehicle sends a local map request to a server, the local map request includes current location data of the vehicle, the vehicle includes an autonomous driving vehicle; the vehicle receives a first local map of the current location from the server, the first local map covers a first distance on the route of the vehicle; a sensor mounted on the vehicle collects first surrounding environment data of the vehicle during travelling along the first distance; and based on the first local map and the first surrounding environment data, the vehicle generates map update data and sends the data to the server.

### RELATED APPLICATIONS

This application is a continuation application of PCT application No. PCT/CN2018/124448, filed on Dec. 27, 2018, and the content of which is incorporated herein by reference in its entirety.

### TECHNICAL FIELD

The present disclosure relates to the field of map construction, and specifically to a map updating system and method that can be used for autonomous driving.

### BACKGROUND

With the development of autonomous driving technology, map construction for autonomous driving becomes particularly important. During driving, autonomous driving vehicles rely on visual positioning maps that are different from ordinary maps to locate themselves and make decisions on driving paths and driving strategies. In the existing technologies, the characteristics of the road environment in a specific area may be collected and a map may be constructed by a dedicated professional mapping vehicle. However, this method is not suitable for constructing a larger-scale map, and also cannot guarantee the real-time nature of the map. Only the places where professional mapping vehicles pass by can have corresponding maps, which will undoubtedly limit the range of activities of automatic vehicles. In addition, if changes in road conditions cannot be updated in time, they may compromise the correctness of automatic vehicles' driving decisions.

Therefore, there is a need to provide a map update system and method that can accurately and quickly update changed parts of an existing map and add missing parts.

### SUMMARY

A first aspect of the present disclosure provides an autonomous driving system for updating a map, including: an on-board electronic device including at least one storage medium storing a set of instructions for updating a map and at least one processor in communication with the at least one storage medium, wherein during operation, the at least one processor executes the set of instructions to: send, by a vehicle including the on-board electronic device, a local map request to a server, wherein the local map request includes current location data of the vehicle, and the vehicle includes an autonomous driving vehicle, receive, by the vehicle, a first local map of a current location from the server, wherein the first local map covers a first distance on a route traveled by the vehicle, collect, by a sensor mounted on the vehicle first surrounding environment data of the vehicle during driving along the first distance, generate, by the vehicle, map update data based on the first local map and the first surrounding environment data, and send, by the vehicle, the map update data to the server.

A second aspect of the present disclosure provides a map updating system for autonomous driving, including: a server, including at least one storage medium storing a set of instructions for updating a map and at least one processor in communication with the at least one storage medium, wherein during operation, the at least one processor executes the set of instructions to: receive, by the server, a local map request sent by a vehicle, wherein the local map request includes current location data of the vehicle, and the vehicle includes an autonomous driving vehicle, determine, by the server, a first local map from a global map based on the current location data, send, by the server, the first local map to the vehicle, receive, by the server, map update data sent by the vehicle, and update, by the server, a portion of the global map corresponding to the first local map based on the map update data.

A third aspect of the present disclosure provides a map updating method for autonomous driving, including: sending, by a vehicle, a local map request to a server, wherein the local map request includes current location data of the vehicle, and the vehicle includes an autonomous driving vehicle; receiving, by the vehicle, a first local map of a current location from the server, wherein the first local map covers a first distance on a route traveled by the vehicle; collecting, by a sensor mounted on the vehicle, first surrounding environment data of the vehicle during driving along the first distance; generating, by the vehicle, map update data based on the first local map and the first surrounding environment data; and sending, by the vehicle, the map update data to the server.

A fourth aspect of the present disclosure provides a map updating method for autonomous driving, including: receiving, by a server, a local map request sent by a vehicle, wherein the local map request includes current location data of the vehicle, and the vehicle includes an autonomous driving vehicle; determining, by the server, a first local map from a global map based on the current location data; sending, by the server, the first local map to the vehicle; receiving, by the server, map update data sent by the vehicle; and updating, by the server, a portion of the global map corresponding to the first local map based on the map update data.

### BRIEF DESCRIPTION OF DRAWINGS

The following drawings illustrate in detail some exemplary embodiments provided in the present disclosure. The same reference numerals indicate similar structures in the drawings. A person of ordinary skill in the art will understand that these embodiments are non-limiting exemplary embodiments. The drawings are only used for the purpose of illustration and description, and are not intended to limit the scope of the present application. Other embodiments may also achieve the objects of the present disclosure.

FIG. 1 is a schematic scenario diagram of map update by a common autonomous driving vehicle according to some exemplary embodiments of the present disclosure;

FIG. 2 is a schematic diagram of a wireless communication system for mobile device network management according to some exemplary embodiments of the present disclosure;

FIG. 3 is a block diagram of an exemplary vehicle with autonomous driving capability according to some exemplary embodiments of the present disclosure;

FIG. 4 is a schematic diagram of exemplary hardware and software components of an information processing unit according to some exemplary embodiments of the present disclosure;

FIG. 5 is an exemplary flowchart of a map update method for autonomous driving according to some exemplary embodiments of the present disclosure;

FIG. 6 is an exemplary flowchart of a method for matching a first local map with second surrounding environment data according to some exemplary embodiments of the present disclosure;

FIG. 7 is an exemplary flow chart of dynamic interactions between a vehicle and a server according to some exemplary embodiments of the present disclosure;

FIG. 8 is a schematic diagram of an on-board electronic device according to some exemplary embodiments of the present disclosure; and

FIG. 9 is a schematic diagram of a server device according to some exemplary embodiments of the present disclosure.

### DETAILED DESCRIPTION

The present disclosure discloses a system and method for updating a map with an on-board device of a common autonomous driving vehicle. The map may include a visual positioning map, and a vehicle with an autonomous driving function (hereinafter a vehicle with an autonomous driving function may be referred to as an “autonomous driving vehicle”) may perform autonomous driving according to the visual positioning map. Since the storage capacity required by the visual positioning map is relatively large, the visual positioning map may be stored in a cloud server. An autonomous driving vehicle may dynamically obtain a local map of its current location from the cloud server during driving to satisfy its driving needs within a certain period of time.

A cloud server may store a global map. Compared with a local map, a global map may include a larger area, such as a map of a city, a map of a country, and so on. Since a global map covers a large area, it cannot meet the demand if it only relies on vehicles with professional mapping equipment to continuously collect and update data. The solution proposed by the present disclosure allows a common vehicle with certain mapping capability (mapping vehicles) to collect environmental data around a road section it drives by during a normal driving process and then upload the collected data to a cloud server, so as to update a corresponding global map. The mapping vehicle may include, but is not limited to, a common autonomous driving vehicle. A common autonomous driving vehicle may be a vehicle without professional mapping equipment, and the universal sensors it carries are non-professional commercial sensors, which can map the surrounding environment during vehicle driving. The universal sensors include lidars, vision sensors (monocular camera, binocular camera, etc.) and the like.

In the case where a cloud server cannot provide a sufficiently detailed local map or the local map has errors, after a mapping vehicle downloads the local map from the cloud server, it will collect data, preliminarily process the collected data and then upload the preliminarily processed data to the cloud server, so as to complete the supplementary construction of the cloud map. Alternatively, a mapping vehicle may directly upload the collected data to the cloud server without data processing, and the cloud server completes the mapping work. Due to the huge amount of data of a visual positioning map, the data interaction process relies on sufficiently fast network uplink and downlink. For example, a 5G network or a network with a bandwidth of not less than 100 Mbps may provide a good network environment, which is helpful for updating a global map by a common automatic vehicle. It should be understood that a good network environment is conducive to the implementation of the method described in the present disclosure, such as a network with a bandwidth of 200 Mbps, 400 Mbps, and up to 1 Gbps.

In order to provide a person of ordinary skill in the art with a thorough understanding of the relevant disclosure, the following detailed description provides examples to illustrate certain specific details of the present disclosure. However, the content disclosed in the present disclosure should be understood as consistent with the scope of protection defined by the claims, and is not limited to the specific details described. For example, it would be obvious to a person of ordinary skill in the art to make various modifications to the embodiments disclosed in the present disclosure. Without departing from the scope of the present disclosure, a person of ordinary skill in the art may apply the general principles defined herein to other embodiments and applications. In another example, if some details are not disclosed herein, a person of ordinary skill in the art may also practice the present disclosure without knowing these details. Moreover, in order to avoid unnecessarily obscuring the necessary content of the present disclosure, the present disclosure provides a general overview of certain well-known methods, processes, systems, components and/or circuits without detailed descriptions. Therefore, the content disclosed in the present disclosure is not limited to the illustrated exemplary embodiments, but is consistent with the scope defined by the appended claims.

The terms used in the present disclosure are only for the purpose of describing certain specific exemplary embodiments, and are not restrictive. For example, unless the context clearly indicates otherwise, if a singular description of an element is used in the present disclosure (for example, “a”, “an” and/or an equivalent expression), a plurality of such elements may also be included. The terms “comprising” and/or “including” used in the present disclosure indicate an open-ended coverage. For example, A comprising/including B merely refers to that there is a B feature in A, yet it does not exclude the possibility that another element(s) (such as C) exist in or be added to A.

It should be understood that certain terms used in the present disclosure, such as “system”, “unit”, “module” and/or “block”, are used to distinguish different components, elements, parts, or members at different levels. However, if other terms can achieve the same purpose, they may also be used in the present disclosure to replace the above-mentioned terms.

The modules (or units, blocks, units) described in the present disclosure may be implemented as software and/or hardware modules. Unless the context clearly dictates otherwise, when a unit or module is described as being “communicated with”, “connected to” or “coupled to” another unit or module, this may refer to that the unit or module is directly communicated with, connected to, or coupled to another unit or module, it may also refer to that the unit or module is indirectly communicated with, connected to, or coupled to another unit or module. In the present disclosure, the term “and/or” includes any and all combinations of one or more listed related items.

In the present disclosure, the term “autonomous driving vehicle” may refer to a vehicle that has the ability to perceive its environment, and automatically perceive, judge and make decisions based on the external environment without human (e.g., a driver, a pilot, etc.) input and/or intervention. The terms “autonomous driving vehicle” and “vehicle” can be used interchangeably herein. The term “autonomous driving” may refer to the ability to make intelligent judgments and navigate the surrounding environment without human (e.g., a driver, a pilot, etc.) input. Moreover, the term “autonomous driving” herein may refer to any level of driving without or with only limited human intervention. For example, the term “autonomous driving” may include, but not limited to, any one of autonomous driving, automated driving, self-driving, and driverless as interchangeable.

In consideration of the following description, the present disclosure's operation and function of these features and other features, as well as related elements of the structure, as well as the combination of components and the economics of manufacturing can be significantly improved. With reference to the drawings, all of these constitute part of the present disclosure. However, it should be understood that the drawings are only for illustration and description purposes, and are not intended to limit the scope of the present disclosure. It should be understood that the drawings are not drawn to scale.

The flowcharts provided in the present disclosure illustrate operations implemented by the system according to some exemplary embodiments of the present disclosure. It should be understood that the operations shown in the flowcharts may be performed in a different order. The operations may be performed in a different order or performed simultaneously. In addition, one or more other operations can be added to the flowcharts, and one or more operations can be removed from the flowcharts.

The positioning technology used in the present disclosure may be based on Global Positioning System (GPS), Global Navigation Satellite System (GLONASS), Compass Navigation System (COMPASS), Galileo Positioning System, Quasi-Zenith Satellite System (QZSS), Wireless Fidelity (Wi-Fi)) positioning technology, etc., or any combination thereof. One or more of the above positioning systems may be used interchangeably in the present disclosure.

Moreover, although the system and method provided in the present disclosure mainly describe the map update system and method that can be used for autonomous driving, it should be understood that these are only some exemplary embodiments. The system and method of the present disclosure can be applied to any other types of transportation systems. For example, the system and method of the present disclosure may be applied to various transportation systems in different environments, including land, sea, aerospace, etc., or any combination thereof. The autonomous driving vehicles of a transportation system may include, but are not limited to, taxis, private cars, trailers, buses, trains, bullet trains, high-speed railways, subways, ships, airplanes, spacecraft, hot air balloons, autonomous driving vehicles, etc., or any combination thereof. In some exemplary embodiments, the system and method of the present disclosure can find applications in logistics warehouses and military affairs, for example.

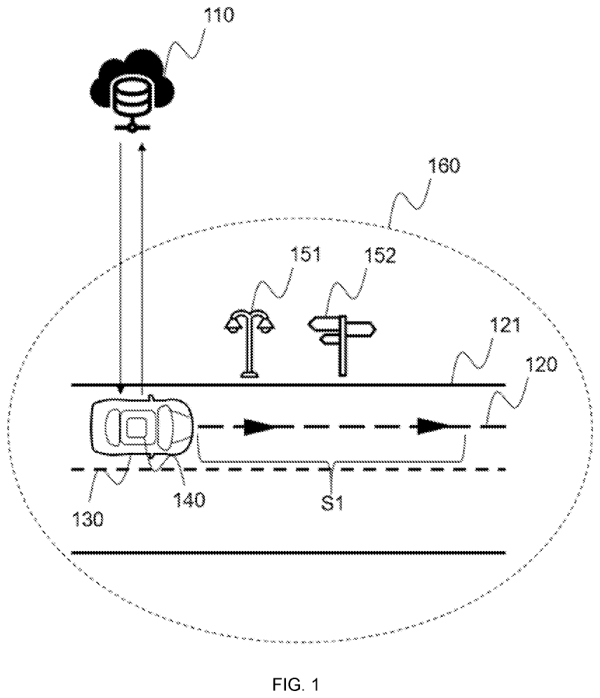

FIG. 1 is a schematic scenario diagram of map update by a common autonomous driving vehicle according to some exemplary embodiments of the present disclosure. As shown in FIG. 1, a vehicle 130 travels along a route 120 on a road 121. The vehicle 130 may be a common autonomous driving vehicle, rather than a mapping vehicle equipped with professional mapping equipment. The vehicle 130 may be equipped with a universal sensor 140. The universal sensor 140 may have a certain mapping capability. For example, when the vehicle 130 is traveling, the universal sensor 140 may collect surrounding environmental data. A processing device (not shown in the figure) of the vehicle 130 may reconstruct a visual positioning map of the surrounding environment based on the surrounding environment data collected by the universal sensor 140. In some exemplary embodiments, the universal sensor 140 may include a sensor group used by the common autonomous driving vehicle for normal driving, such as a lidar, a millimeter wave radar, an ultrasonic radar, a camera (monocular camera, binocular camera, etc.). In some exemplary embodiments, the universal sensor 140 may also be a simple mapping device with a certain mapping capability. For example, the simple mapping device may be installed on a private car. During the daily driving of the private car, the simple mapping device may collect surrounding environment data and then perform mapping.

In some exemplary embodiments shown in FIG. 1, a data interaction link may be established between the vehicle 130 and a server 110. The vehicle 130 may upload a local map of a reconstructed area 160 to the server 110, thereby updating the part of a global map corresponding to the area 160. In some exemplary embodiments of the present disclosure, the map for autonomous driving may include a visual positioning map. The visual positioning map may include a plurality of landmark points. Each landmark point may include the visual feature information of the landmark point and the three-dimensional space information of the landmark point. For example, in FIG. 1, a street lamp 151 and a street sign 152 are the landmark points in the local map corresponding to the area 160. Taking the street lamp 151 as an example, a corresponding landmark point in the visual positioning map may include the visual features (such as shape, contour, texture, color, etc.) of the street lamp 151, as well as the position information and dimensional information of the street lamp 151 in space. An autonomous driving vehicle may locate itself based on the visual feature information and three-dimensional spatial information of multiple road signs.

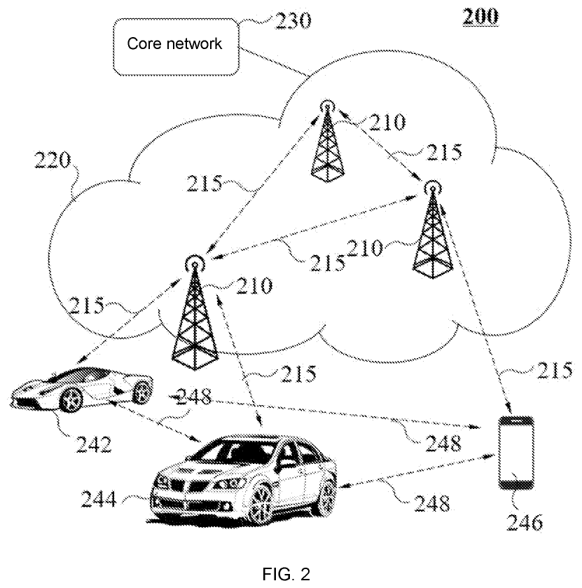

FIG. 2 is a schematic diagram of a wireless communication system for mobile device network management according to some exemplary embodiments of the present disclosure. The mobile device network management system may be used as a supporting network in the present disclosure.

A wireless communication system 200 may include remote units 242, 244, and 246, a base station 210, and wireless communication links 215 and 248. A specific number of remote units 242, 244, 246, base stations 210 and wireless communication links 215, 248 are depicted in FIG. 2. However, a person skilled in the art would understand that the wireless communication system 200 may include any number of remote units 242, 244, 246, base stations 210, and wireless communication links 215, 248.

In some exemplary embodiments, the remote units 242, 244, 246 may be mobile devices, such as on-board computers (including on-board computers of human driving vehicles and/or autonomous driving vehicles) 242, 244, and other mobile devices 246, such as mobile phones, notebook computers, personal digital assistants (“PDAs”), tablet computers, smart watches, fitness bands, optical head-mounted displays, etc. The remote units 242, 244, 246 may also include non-mobile computing devices, such as desktop computers, smart TVs (for example, TVs connected to the Internet), set-top boxes, game consoles, security systems (including surveillance cameras), fixed Network equipment (for example, routers, switches, modems), etc. In addition, the mobile remote units 242, 244, 246 may be referred to as mobile stations, mobile devices, users, terminals, mobile terminals, fixed terminals, subscriber stations, UEs, user terminals, devices, or other terms used in the art.

Wireless links between the remote units 242, 244, and 246 are 248. The wireless links between the remote units 242, 244, and 246 may be 5G communication interactions or other wireless interactions, such as Bluetooth, Wi-Fi, etc. The base stations 210 may form a radio access network (RAN) 220. The wireless links between the base stations 210 are 215. The RAN 220 may be coupled to a mobile core network 230 for communication. The mobile core network 230 may be a 5G network, or a 4G, 3G, 2G, or other form of network. In this disclosure, a 5G network is taken as an example to illustrate the present disclosure. When the remote units communicate with the base stations 210, any communication environment of 2G to 4G may be used. However, since the communication has high requirements on network delay and data transmission speed, a 5G network environment is more suitable for communication between the vehicles. The data transmission rate of 4G is in the order of 100 Mbps, the delay is 30-50 ms, the maximum number of connections per square kilometers is in the order of 10,000, and the mobility is about 350 km/h, while the transmission rate of 5G is on the order of 10 Gbps, the delay is 1 ms, the maximum number of connections per square kilometers is in the order of millions, and the mobility is about 500 km/h. 5G has a higher transmission rate, shorter delay, more connections per square kilometers, and higher speed tolerance. Another change in 5G is the change of transmission route. In the past, for making a call or sending a photo, the signal had to be relayed by base stations. However, since 5G, signals can be directly transmitted between devices without base stations. Therefore, although the present disclosure is applicable to a 4G environment, it will have better technical performance and higher commercial values when running in a 5G environment.

The 5G mobile core network 230 may belong to a single public land mobile network (PLMN). For example, the mobile core network 230 may provide low-latency and high-reliability services, for example, in the field of autonomous driving. The mobile core network 230 may also provide services to meet the requirements of other application. For example, the mobile core network 230 may provide high data rate and medium delay traffic services; for example, it may provide services to mobile devices such as mobile phones; for example, the mobile core network 230 may also provide services such as low mobility and low data rate services.

The base stations 210 may serve a plurality of remote units 242, 244, 246 in a service area, for example, a cell or a cell sector, wireless communication links. The base stations 210 may directly communicate with one or more remote units 242, 244, 246 via communication signals. The remote units 242, 244, 246 may directly communicate with one or more base stations 210 via uplink (UL) communication signals. In addition, the UL communication signals may be carried through wireless communication links 215, 248. The base stations 210 may also transmit downlink (DL) communication signals to serve the remote units 242, 244, 246 in a time domain, a frequency domain, and/or a space domain. Moreover, the DL communication signals may be carried by the wireless communication link 215. The wireless communication link 215 may be any suitable carrier in a licensed or unlicensed radio spectrum. The wireless communication link 215 may communicate with one or more remote units 242, 244, 246 and/or one or more base stations 210. In some exemplary embodiments, the wireless communication system 200 may comply with the long-term evolution (LTE) of the 3GPP protocol, in which the base stations 210 may use an orthogonal frequency division multiplexing (OFDM) modulation scheme on the DL to send signals. The remote units 242, 244, 246 may use a single-carrier frequency division multiple access (SC-FDMA) scheme to transmit data on the UL. More generally, the wireless communication system 2200 may implement some other open or proprietary communication protocols, such as WiMAX, and other protocols. However, the present disclosure is not intended to be limited to the implementation of any specific wireless communication system architecture or protocol.

The base stations 210 and remote units 242, 244, 246 may be distributed over a geographical area. In some exemplary embodiments, the base stations 210 and the remote units 242, 244, 246 may also be referred to as access points, access terminals, or any other term used in the art. Generally, two or more geographically adjacent base stations 210 or remote units 242, 244, 246 may be grouped together to become a routing area. In some exemplary embodiments, the routing area may also be referred to as a location area, a paging area, a tracking area, or any other term used in the art. Each “routing area” has an identifier sent from a serving base station 210 to the remote units 242, 244, 246 (or between the remote units 242, 244, 246).

When the mobile remote units 242, 244, 246 move to a new cell (for example, move within the range of a new base station 210) that broadcasts a different “routing area,” the mobile remote units 242, 244, 246 may detect a change in the routing area. The RAN 220 then pages the mobile remote units 242, 244, 246 in an idle mode via the base stations 210 in the current routing area. The RAN 220 may include multiple routing areas. As known in the art, the size of the routing area (for example, the number of base stations included in the routing area) can be selected to balance the routing area update signaling load with the paging signaling load.

In some exemplary embodiments, the remote units 242, 244, 246 may be attached to the core network 230. When the remote units 242, 244, 246 detect a mobile device network management event (for example, a change in the routing area), the remote units 242, 244, 246 may send a mobile device network management request to the core network 230 (for example, a low-latency and high-reliability service required by autonomous driving or a high-data-rate and medium-latency traffic service required by mobile phones). Subsequently, the core network 230 may forward the mobile device network management request to one or more auxiliary network sections connected to the remote units 242, 244, 246 so as to provide corresponding services.

At a certain moment, the remote units 242, 244, 246 may no longer need a certain network service (for example, the low-latency and high-reliability service required by autonomous driving or the high-data rate and medium-latency traffic service required by mobile phones). In such a case, the remote units 242, 244, 246 may send a separation request message, such as a data connection release message, to be separated from the network.

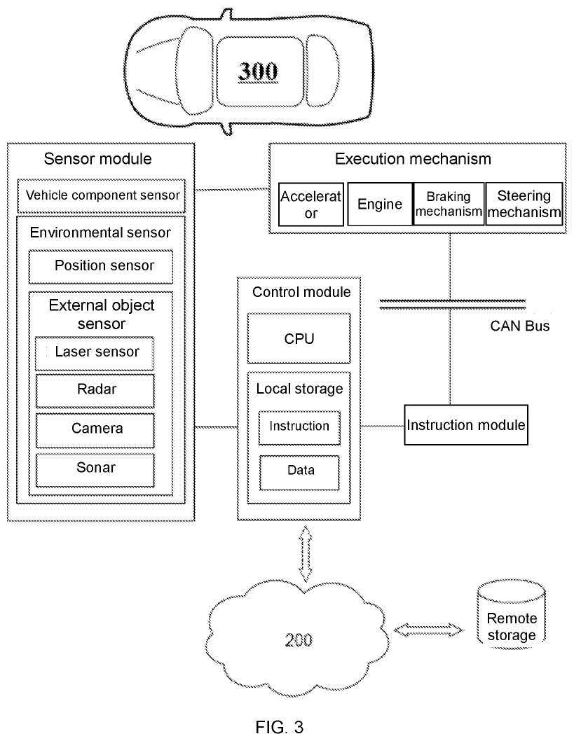

FIG. 3 is a block diagram of an exemplary vehicle with autonomous driving capability according to some exemplary embodiments of the present disclosure. A vehicle 300 may be the vehicles 242 and 244 in the wireless communication system 200 managed by the mobile device network as shown in FIG. 2. For example, the vehicle 300 with an autonomous driving capability may include a control module, a plurality of sensors, a storage device, an instruction module, a controller area network (CAN), and an execution mechanism.

The execution mechanism may include, but is not limited to, the driving execution of an accelerator, an engine, a braking system, and a steering system (including the steering of tires and/or the operation of turn signals).

The plurality of sensors may include various internal and external sensors that provide data to the vehicle 300. For example, as shown in FIG. 3, the plurality of sensors may include vehicle component sensors and environmental sensors. The vehicle component sensors are connected to the execution mechanism of the vehicle 300, and can detect the operating status and parameters of various components of the execution mechanism.

The environmental sensors may allow the vehicle to understand and potentially respond to its environment in order to help the autonomous driving vehicle 300 perform navigation, route planning, and ensure the safety of vehicles passengers and people or properties in the surrounding environment. The environmental sensors may also be used to identify, track and predict the movement of certain objects, such as pedestrians and other vehicles. The environmental sensors may include a position sensor(s) and an external object sensor(s).

The position sensor(s) may include a GPS receiver, an accelerometer and/or a gyroscope, a receiver, etc. The position sensor may sense and/or determine multiple geographic locations and orientations of the autonomous driving vehicle 300, for example, determine the latitude, longitude and altitude of the vehicle.

The external object sensors may detect objects outside the vehicle, such as other vehicles, obstacles in the road, traffic signals, signs, trees, etc. The external object sensors may include laser sensors, radars, cameras, sonar, and/or other detection devices.

Laser sensors may measure the distance between the vehicle and the surface of an object facing the vehicle by rotating on an axis thereof and changing the distance. The laser sensors may also be used to identify changes in surface texture or reflectivity. Hence, the laser sensors may be configured to detect a lane line by distinguishing the amount of light reflected by the painted lane line as compared with the unpainted relatively dark road surface.

Radar sensors may be arranged on the front portion and rear portion of a vehicle and on either side of a front bumper. In addition to using radar to determine the relative position of an external object, other types of radars may also be used for other purposes, for example, as traditional speed detectors. A shortwave radar may be used to determine the depth of snow on the road and determine the location and condition of the road.

Cameras may capture a visual image around the vehicle 300 and extract content from it. For example, the cameras may take pictures of street signs on both sides of the road and recognize the meaning of these signs through the control module. For example, cameras may be used to obtain the speed limit of the road. The vehicle 300 may calculate the distance of a surrounding object(s) from the vehicle 300 based on the parallax of different images taken by multiple cameras.

Sonar may detect the distance between the vehicle 300 and an obstacle(s). For example, the sonar may be an ultrasonic rangefinder(s). Ultrasonic rangefinders may be mounted on both sides and the back of the vehicle, and may be turned on when parking so as to detect obstacles around the parking space and the distance between the vehicle 300 and the obstacles.

After receiving information sensed by multiple sensors, the control module may process information and/or data related to vehicle driving (for example, autonomous driving) in order to perform one or more functions described in the present disclosure. In some exemplary embodiments, the control module may be configured to autonomously drive the vehicle. For example, the control module may output multiple control signals. The multiple control signals may be configured to be received by one or more electronic control units (ECUs) to control the driving of the vehicle. In some exemplary embodiments, the control module may determine a reference route and one or more candidate routes based on the environmental information of the vehicle.

In some exemplary embodiments, the control module may include one or more central processors (for example, single-core processors or multi-core processors). For example, the control module may include a central processing unit (CPU), an application-specific integrated circuit (ASIC), an application-specific instruction-set processor (ASIP), a graphics processing unit (GPU), a physics processing unit (PPU), a digital signal processor (DSP), a field programmable gate array (FPGA), a programmable logic device (PLD), a controller, a microcontroller unit, a reduced instruction-set computer (RISC), a microprocessor, etc., or any combinations thereof.

The storage device may store data and/or instructions. In some exemplary embodiments, the storage device may store data obtained by the sensors of the autonomous driving vehicles. In some exemplary embodiments, the storage device may store data and/or instructions that can be executed or used by the control module to perform the exemplary methods described in the present disclosure. In some exemplary embodiments, the storage device may include a mass storage device, a removable storage device, a volatile read-and-write storage device, a read-only memory (ROM), etc., or any combinations thereof. For example, the mass storage device may include a magnetic disk, an optical disk, a solid-state drive, etc.; for example, the removable storage device may include a flash drive, a floppy disk, an optical disk, a memory card, a zipper disk, a magnetic tape, etc.; for example, the volatile read-write storage device may include a random access memory (RAM); for example, the RAM may include dynamic RAM (DRAM), double data rate synchronous dynamic RAM (DDR SDRAM), static RAM (SRAM), thyristor RAM (T-RAM), zero capacitor RAM (Z-RAM), etc.; for example, the ROM may include a mask ROM (MROM), a programmable ROM (PROM), an erasable programmable ROM (EPROM), an electrically erasable programmable ROM (EEPROM), a compact disk ROM (CD-ROM), a digital universal disk ROM, etc. In some exemplary embodiments, the storage device may be implemented on a cloud platform. For example, the cloud platform may include a private cloud, a public cloud, a hybrid cloud, a community cloud, a distributed cloud, an inter-cloud cloud, a multi-cloud, etc., or any combinations thereof.

In some exemplary embodiments, the storage device may be a local storage device, that is, the storage device may be part of the autonomous driving vehicle 300. In some exemplary embodiments, the storage device may also be a remote storage device. A central processing unit may be connected to the remote storage device via the network 200 to communicate with one or more components (for example, the control module, the sensor module) of the autonomous driving vehicle 300. One or more components in the autonomous driving vehicle 200 may access data or instructions remotely stored in the remote storage device via the network 200. In some exemplary embodiments, the storage device may be directly connected to or communicate with one or more components in the autonomous driving vehicle 300 (for example, the control module, the sensors).

The instruction module may receive information from the control module, convert it into an instruction(s) for driving the execution mechanism and then send it to a controller area network (CAN) bus. For example, the control module may send a driving strategy (acceleration, deceleration, steering, etc.) of the autonomous driving vehicle 200 to the instruction module, and the instruction module receives the driving strategy and converts it into a driving instruction(s) for the execution mechanism (driving instructions for accelerator, braking mechanism, steering mechanism, etc.). At the same time, the instruction module may issue the instruction(s) to the execution mechanism via the CAN bus. The execution of the instruction(s) by the execution mechanism is then detected by the vehicle component sensors and then fed back to the control module, thereby completing closed-loop control and driving of the autonomous driving vehicle 300.

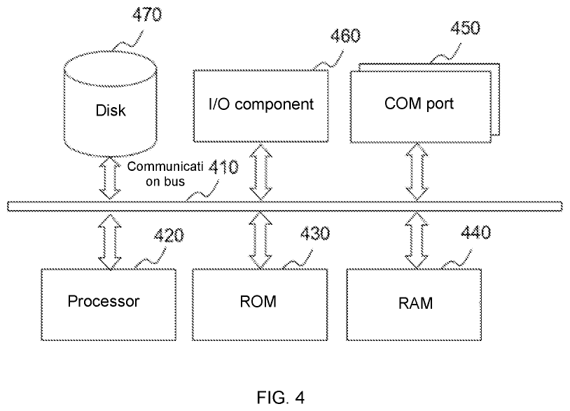

With reference to FIG. 1-3 and FIG. 4, where FIG. 4 is a schematic diagram of exemplary hardware and software components of an information processing unit according to some exemplary embodiments of the present disclosure, it can be seen that an information processing unit 400 may execute a method for implementing data interaction between a server and the vehicle 130 and update the map. For example, the cloud server(s) and/or base station(s) (collectively referred to as the server) as shown in FIG. 3 may include at least one of the information processing unit 400, and the information processing unit 400 may distribute a local map to the vehicle according to a request of the vehicle, receive map update data, and then update a corresponding global map.

The information processing unit 400 may be a dedicated computer device specially designed for map updating. For example, the information processing unit 400 may include a COM port 450 connected to a network connected thereto to facilitate data communication. The information processing unit 400 may further include a processor 420, and the processor 420 may be in the form of one or more processors for executing computer instructions. The computer instructions may include, for example, routines, programs, objects, components, data structures, procedures, modules, and functions that perform specific functions as described herein. The processor 420 may determine a local map according to a request of the vehicle and send the map to the vehicle via an I/O component 460. In addition, the processor 420 may also update the map according to the map update data returned by the vehicle.

In some exemplary embodiments, the processor 420 may include one or more hardware processors, such as a microcontroller, a microprocessor, a reduced instruction set computer (RISC), an application specific integrated circuit (ASIC), an application-specific instructions-set processor (ASIP), a central processing unit (CPU), a graphics processing unit (GPU), a physics processing unit (PPU), a microcontroller unit, a digital signal processor (DSP), a field programmable gate array (FPGA), an advanced RISC machine (ARM), a programmable logic device (PLD), any circuit or processor capable of performing one or more functions, or any combinations thereof.

The information processing unit 400 may include an internal communication bus 410, program storage, and different forms of data storage devices (for example, a magnetic disk 470, a read only memory (ROM) 430, or a random access memory (RAM) 440) for various data files processed and/or sent by a computer. A global map may be stored in the storage device. The information processing unit 400 may further include program instructions stored in the ROM 430, the RAM 440 and/or other types of non-transitory storage media to be executed by the processor 420. The method and/or process of the present disclosure may be implemented as program instructions. The information processing unit 400 may further includes an I/O component 460, which supports input/output between the computer and other components (for example, a user interface component). The information processing unit 400 may also receive programs and data through network communication.

For the purpose of description only, one processor is described in the information processing unit 400 in the present disclosure. However, it should be noted that the information processing unit 400 in the present disclosure may also include multiple processors. Therefore, the operations and/or method steps disclosed in the present disclosure may be performed by one processor as described in the present disclosure, or may be performed jointly by multiple processors. For example, if the processor 420 of the information processing unit 400 performs step A and step B in the present disclosure, it should be understood that step A and step B may be performed jointly or separately by two different processors in the information processing (for example, a first processor may execute step A, a second processor may execute step B, or the first and second processors jointly execute steps A and B).

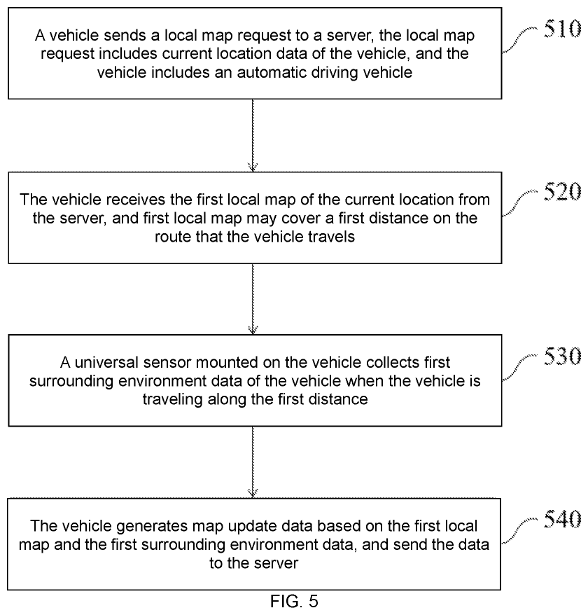

FIG. 5 is an exemplary flowchart of a map update method for autonomous driving according to some exemplary embodiments of the present disclosure. The method may include: the vehicle 130 requesting a local map corresponding to a local area from a server, the server 110 issuing the local map according to the request of the vehicle 130, and the vehicle 130 receiving the local map, collecting data in the local area to generate map update data, and uploading the collected data to the server 110. The server 110 may subsequently update a corresponding global map stored therein according to the map update data. For demonstration purposes only, this disclosure will take an autonomous driving vehicle as an example to describe the present disclosure. However, a person of ordinary skill in the art would understand that the present disclosure may also be applied to a human-driving vehicle. For example, a human-driving vehicle may be equipped with sensors with certain mapping capabilities, which may also participate in the map update system during its daily driving. In another example, when the autonomous driving vehicle is in the human-driving mode, the data collected by the universal sensor 140 may be used for mapping rather than autonomous driving. The on-board electronic device of the vehicle 130 may include at least one set of the structures shown in FIG. 4 for communicating with the server 110 and processing data collected by the universal sensor 140.

In 510, the vehicle 130 may send a local map request to the server 110. The local map request may include current location data of the vehicle. Corresponding to FIG. 1, the vehicle 130 may send the local map request to the server 110 when the vehicle 130 is at the position shown in the figure. After receiving the local map request, the server 110 may search the stored global map to determine the first local map sent to the vehicle 130.

In some exemplary embodiments, the storage device of the server 110 may pre-store a global map. The global map may include a map of a city, such as a map of Beijing. The global map may be stored using certain database technology, and the granularity of storage may be landmark point data, and the landmark point data may include three-dimensional spatial information, visual feature information, positioning effect information, and a group marker of the landmark point. The positioning effect information may include a series of feedback data, and each piece of feedback data may be available/unavailable data of the landmark point data fed back by a certain autonomous driving vehicle(s) after using the landmark point data. The group mark herein indicates that the landmark point may be used together in the same local map with other landmark points with the same group mark.

In some exemplary embodiments, the server 110 may determine the first local map according to the current location of the vehicle 130. For example, the server 110 may determine a circular first local map with the current position as the center of the circle. For another example, the server 110 may pre-store a map divided into several areas, and the server 110 may search for and determine the preset area where the current location is located. In some exemplary embodiments, the local map request may further include performance data of the on-board electronic device of the vehicle 130 (for example, the storage capacity of its memory). The server 110 may determine the size of the first local map according to the performance data of the on-board electronic device of the vehicle 130. It should be understood that the map described in the present disclosure may include a visual positioning map, and the visual positioning map may be shown in the form of a number of landmark points, and the size of the map indicates the number of landmark points contained within a certain geographic area. For example, the first local map may be a collection of all landmark points within a 200-meter radius of the current location of the vehicle 130. In another example, when the performance data of the on-board electronic device of the vehicle 130 is at a higher level, the first local map may be a collection of all road marking points within a 500-meter radius of the current location of the vehicle 130.

In some exemplary embodiments, the local map request may further include a driving direction of the vehicle 130. The server 110 may determine the first local map based on the current location and the driving direction of the vehicle 130. For example, in some exemplary embodiments shown in FIG. 1, the vehicle 130 may also send its driving route 120 to the server 110. The server 110 may determine, based on the driving route 120, the local map corresponding to the area 160 that the vehicle will travel to be the first local map. When the vehicle 130 is an autonomous driving vehicle and is in its autonomous driving mode, the driving route 120 may be the route decided by the vehicle 130 at a previous moment. If the vehicle 130 is a human-driving vehicle, or when the autonomous driving vehicle is in its human-driving mode, the driving direction may be the direction pointed by the head of the vehicle at the current position.

In some exemplary embodiments, the local map request may further include an area range corresponding to the first local map. For example, the vehicle 130 may determine the area 160 based on the performance data of its on-board electronic device and its driving route 120, so that the first local map obtained from the server 110 may meet the driving demand or maximum processing capacity for a certain period of time in the future.

A search result of the server 110 in the global map based on the local map request may be the first local map is found or the first local map cannot be found. The server 110 may send the first local map to the vehicle 130 if it is available. If the first local map is not found, the first local map sent to the vehicle 130 may be blank, and may further include a request instruction, which may be used to instruct the vehicle 130 to construct a first local map.

In 520, the vehicle 130 may receive the first local map from the server 110. The first local map may cover a first distance on the route 120 that the vehicle travels or will travel. For example, in FIG. 1, the first local map may be a collection of landmark points in the area 160, such as street lamps 151, street signs 152, and so on. The first distance may be the road section S1 on the route 120. After the vehicle 130 has traveled through the road section S1, the collected data may be packaged and sent to the server 110 after processing.

In 530, the universal sensor 140 mounted on the vehicle 130 may collect first surrounding environment data of the vehicle when the vehicle is traveling along the first distance. The first surrounding environment data includes data that can be used to reconstruct a visual positioning map of the region corresponding to the first distance. The universal sensor 140 may perform data collection multiple times during the process of the vehicle traveling along the first distance, and the multiple collected data become the first surrounding environment data. In some exemplary embodiments, the multiple data collections may include collecting data for every time interval, or collecting for every driving distance interval, and so on. The first surrounding environment data may include a first feature point se. When the vehicle 130 receives the first local map, it can perform a first data collection at its current location, and the collected data would the second surrounding environment data, which may include a second feature point set. The second surrounding environment data may be considered as a subset (or a frame) of the first surrounding environment data. The method may further include matching the first surrounding environment data with the first local map, and performing subsequent data processing based on the matching result (see FIG. 5 and related descriptions for more detail).

In some exemplary embodiments, in the case where the vehicle 130 is an autonomous driving vehicle, when it receives the first local map, it may position itself based on the first local map, and plan its driving strategy within a range of the first local map based on a positioning result.

In some exemplary embodiments, in the first feature point set, feature point data corresponding to each feature point may include visual feature information and three-dimensional space information of the feature points. Similarly, in the second feature point set, feature point data corresponding to each feature point may include visual feature information and three-dimensional space information of the feature points.

In 540, the vehicle may generate map update data based on the first local map and the first surrounding environment data, and send the data to the server 110. The generation of the map update data may adopt different generation solutions according to differences between the first local map and the first surrounding environment data.

When the first local map is blank and contains an instruction to request the vehicle 130 to create a map (that is, when the server 110 cannot find the first local map, the returned first local map would be blank, and the server may send an instruction to request the vehicle 130 to collect a map of the current environment and then end it to the server 110), the vehicle 130 may use its own mapping capability to generate a local map corresponding to the first distance as the map update data according to the first surrounding environment data collected by the vehicle 130. The first surrounding environment data may include sensor data of a range corresponding to the first distance collected by a sensor mounted on the vehicle 130. For example, when the first distance is 100 meters and the sensor is a camera, the first surrounding environment data may be multiple frames of image data captured by the camera when the vehicle 130 is traveling along the 100 meters.

When the vehicle 130 receives the first local map (that is, when the first local map is not blank), it may firstly try to match the second surrounding environment data with the first local map, The solution for generating the map update data is determined based on a matching result. The second surrounding environment data may include surrounding environment data of the current location of the vehicle 130 collected by sensors mounted on the vehicle 130 when the vehicle 130 receives the first local map. For example, after the vehicle 130 receives the first local map, it may use a camera device it carries to capture images around its current location. In the case where the first local map does not match the second surrounding environment data, the vehicle 130 may identify the first local map as unavailable, and immediately or at an appropriately time point (the vehicle 130 may independently select a time point to make the feedback, or make the feedback at a predetermined time point) send a negative feedback to the server 110 to notify that the first local map is unavailable, and use its own mapping capability to generate a local map corresponding to the first distance based on the first surrounding environment data collected as the map update data. When the vehicle 130 identifies that the first local map is unavailable, the first local map may be deleted to save local storage space.

In the case where the first local map matches the second surrounding environment data, the vehicle 130 may identify the first local map as available, and send a positive feedback notification to the server 110 immediately or at an appropriate time point to notify the first local map is available. The vehicle may generate the map update data based on the first local map. In such a case, the map update data may include new feature points in the first feature point set as compared to the landmark points in the first local map. When the vehicle 130 is in the autonomous driving mode, it may locate itself based on the first local map and create a map while driving along the first distance. The map generation in this case may include adding the new feature points as new landmark points to the first local map so as to generate a new first local map as the map update data.

In some exemplary embodiments, the positive feedback or negative feedback may be uploaded to the server 110 along with the map update data. The server 110 may update the global map after receiving the map update data. In some exemplary embodiments, the server 110 may further combine various data corresponding to the landmark points in the first local map area uploaded by multiple vehicles, and perform processing such as superposition and fusion on the first local map to obtain relatively stable landmark points as an update to the first local map. The positive feedback or negative feedback may reflect the positioning effect of the landmark point data. For example, for landmark point A, when the server 110 receives map update data sent back by several vehicles, based on the positive feedback or negative feedback information included in the map update data, it may determine whether the landmark point A is available for these several vehicles. That is to say, the positioning effect of the landmark point A may be a statistical data indicating the number of times that the landmark point A is available or unavailable.

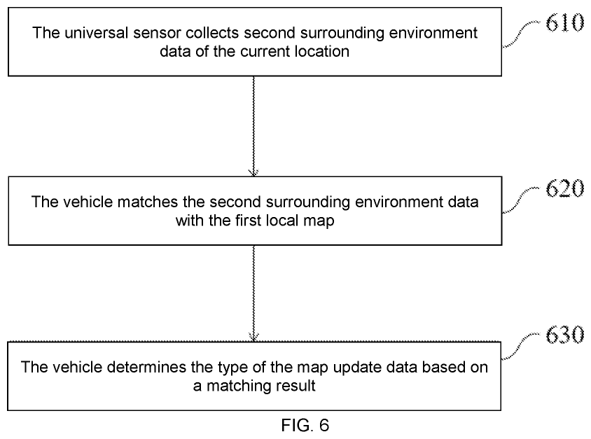

FIG. 6 is an exemplary flowchart of a method for matching a first local map with second surrounding environment data according to some exemplary embodiments of the present disclosure. This process mainly includes matching the feature points in the second feature point set with the landmark points in the first local map to determine whether the first local map is available.

In 610, the universal sensor 140 may collect the second surrounding environment data of the current location. In some exemplary embodiments, the vehicle 130 may collect the second surrounding environment data of the current location after receiving the first local map. According to the description in FIG. 5, the second surrounding environment data may also be a part of the first surrounding environment data. The second surrounding environment data may include a second set of feature points, and each feature point may have its visual feature information and three-dimensional space information.

In 620, the vehicle 130 may match the second surrounding environment data with the first local map. The matching process may include matching feature points in the second feature point set with landmark points in the first local map. For example, for each feature point in the second feature point set, the vehicle 130 may match the visual feature information and three-dimensional space information of the feature point with the visual feature information and three-dimensional space information of each landmark point in the first local map, so as to determine whether the feature point can match one of those landmark points. Further, the number of the feature points in the second feature point set that can be matched with the landmark points in the first local map may be determined. The matching result may be a ratio of the number of matched feature points to the number of all feature points in the second feature point set. For example, the second feature point set may include 100 feature points, and the first local map may include 10,000 landmark points. In the case where 80 feature points can be matched with 80 among the 10,000 landmark points, the number of matches (matched points) is 80, and the ratio is 80%.

In 630, the vehicle 130 may determine the type of the map update data based on the matching result. For example, when the matching result meets requirements, for example, the ratio is greater than a first threshold; it indicates that the first local map is available. A patching strategy may be employed to update a first local part, that is, the newly added feature points may be simply sent to the server. In this case, the feature points in the first set that cannot match the landmark points in the landmark point set may be considered as newly-added feature points, and the map update data may include these newly-added feature points. In some exemplary embodiments, the map update data may further include landmark points in the landmark point set that can match the feature points in the first feature point set. This part of data may be used as positive feedback data and stored in the positioning effect data of the landmark point data.

When the matching result does not meet requirements, for example, when the ratio is less than the first threshold, it indicates that the first local map is not available. The first local map may be updated by employing a replacement strategy, that is, regenerate a first local map and then upload it to the server. The map update data may include the regenerated first local map.

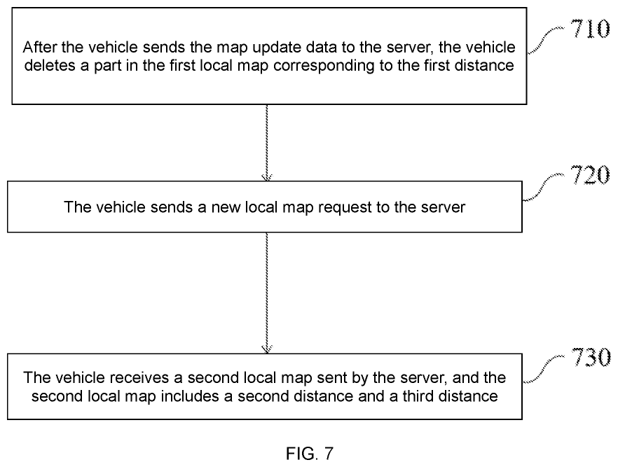

FIG. 7 is an exemplary flow chart of dynamic interactions between a vehicle and a server according to some exemplary embodiments of the present disclosure Due to the performance limitation of the on-board electronic device 130, it may need to dynamically interact with the server during driving to ensure that it can continuously upload map update data.

In 710, after the vehicle 130 sends the map update data to the server 110, the vehicle 130 may delete a part in the first local map corresponding to the first distance. The timing of the vehicle 130 uploading data to the server may be dynamically determined according to network conditions. For example, when the network condition is busy (for example, a local map is being downloaded from the server), the vehicle 130 may first store the map update data locally, and then send it when the network condition improves. After the vehicle 130 sends the map update data to the server 110, it may locally delete a part of the map corresponding to the first distance to save storage resources.

In 720, the vehicle 130 may send a new local map request to the server 110. In some exemplary embodiments, the new local map request may be sent to the server 110 when the vehicle 130 is about to drive out of the area corresponding to the first local map, or It may also be sent to the server 110 when the map update data corresponding to the first distance is generated.

In 730, the vehicle 130 may receive a second local map sent by the server, where the second local map includes a second distance and a third distance. For example, the first local map may include the first distance of 0-100 meters and the second distance of 100-200 meters, and the second local map may include the second distance of 100-200 meters and the third distance of 200-300 meters. When the vehicle 130 travels 100 meters, it may request the second local map of 100-300 meters from the server to replace the first local map originally stored locally, which may ensure that local storage resources are fully utilized and a local map of sufficient scale is available for backup.

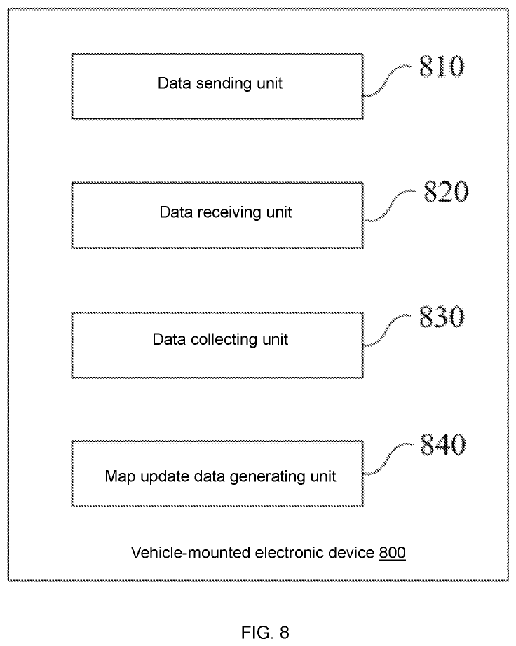

FIG. 8 is a schematic diagram of an on-board electronic device according to some exemplary embodiments of the present disclosure. The on-board electronic device 800 may include a data sending unit 810, a data receiving unit 820, a data collecting unit 830, and a map update data generating unit 840.

The data sending unit 810 may send a local map request to the server. The local map request includes current location data of the vehicle, and the vehicle includes a common autonomous driving vehicle.

The data receiving unit 820 may receive the first local map of the current location from the server. The first local map covers the first distance on the route that the vehicle travels.

The data collecting unit 830 may collect the first surrounding environment data of the vehicle during driving along the first distance.

The map update data generating unit 840 may generate map update data based on the first local map and the first surrounding environment data, and send the map update data to the server via the data sending unit 810.

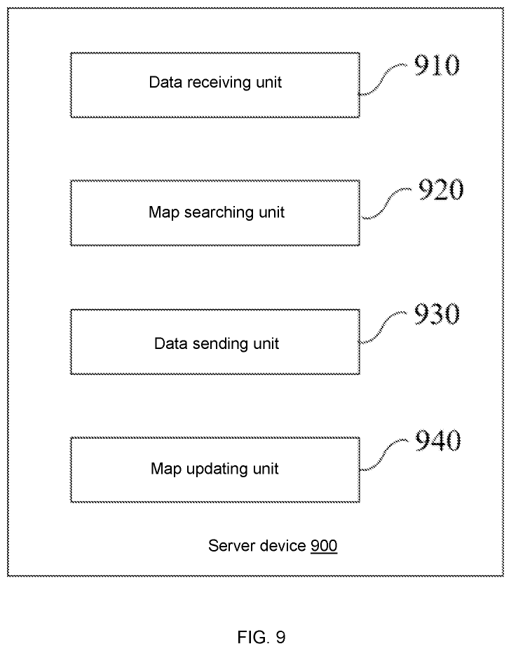

FIG. 9 is a schematic diagram of a server device according to some exemplary embodiments of the present disclosure. The server device 900 may include a data receiving unit 910, a map searching unit 920, a data sending unit 930, and a map updating unit 940.

The data receiving unit 910 may receive a local map request sent by the vehicle. The local map request may include current location data of the vehicle, and the vehicle may include a common autonomous driving vehicle.

The map searching unit 920 may determine the first local map from the global map based on the current location data, and the data sending unit 930 may send the first local map to the vehicle.

The data receiving unit 910 may further receive map update data sent by the vehicle.

The map updating unit 940 may update a part of the global map corresponding to the first local map based on the map update data.

The present disclosure further provides a computer-readable storage medium on which a computer program may be stored. When the computer program is executed by a processor, the steps of the map updating method described herein may be implemented.

After reading this detailed disclosure, a person skilled in the art can understand that the foregoing detailed disclosure is presented by examples, and thus is not restrictive. Although not explicitly stated herein, a person skilled in the art would understand that the present disclosure intends to include various possible changes, improvements and modifications to the exemplary embodiments. These changes, improvements and modifications are intended to be included in the present disclosure, and are within the scope of the present disclosure.

In addition, certain terms in the present disclosure have been used to describe some exemplary embodiments of the present disclosure. For example, “an embodiment,” “embodiments,” and/or “some embodiments” refer to that a specific feature, structure, or characteristic described in conjunction with the embodiment may be included in at least one embodiment of the present disclosure. Therefore, it would be emphasized and should be understood that two or more references to “an embodiment,” “embodiments,” or “some embodiments” in various parts of the present disclosure may not necessarily refer to the same embodiment. In addition, certain features, structures, or characteristics may be appropriately combined in one or more embodiments of the present disclosure.

It should be understood that in the foregoing description of some exemplary embodiments of the present disclosure, in order to help understand a feature, for the purpose of simplifying the present disclosure, sometimes various features may be combined in a single embodiment, drawing or description thereof; or the present disclosure may separate various features in multiple embodiments of the present disclosure. However, this is not to say that the combination of these features is necessary. It would be possible for a person skilled in the art to extract some of the features to form a separate embodiment of the present disclosure. In other words, the embodiments in the present disclosure may also be understood as an integration of multiple sub-embodiments. It may also be true that the content of each sub-embodiment is less than all the features of a single embodiment described herein.

In some exemplary embodiments, numbers for expressing quantities or properties used to describe certain embodiments of the present disclosure should be understood as being qualified by the terms “about”, “approximately” or “substantially” in some cases. For example, unless stated otherwise, “about,” “approximately,” or “substantially” may refer to a ±20% variation of the value disclosed. Therefore, in some exemplary embodiments, the numerical parameters listed in the written description and appended claims may be approximations, which may vary according to the desired properties that a particular embodiment may be intended to achieve. In some exemplary embodiments, the numerical parameters may be interpreted based on the value reported and by applying common rounding methods. Although some exemplary embodiments of the present disclosure list a wide range of numerical values and the parameters are approximate values, the specific examples provide the numerical values that are as accurate as possible.

Each patent, patent application, publication of patent application, and other materials, cited herein, such as articles, books, instructions, publications, documents, articles, etc., may be incorporated herein by reference. The entire contents are for all purposes, except for the history of any prosecution documents related to them, any that may be inconsistent or conflict with this document, or any identical prosecution documents that may have a restrictive effect on the broadest scope of the claims history, associated with this document now or later. For example, if there is any inconsistency or conflict between the descriptions, definitions, and/or use of the terms associated with any of the materials, contained in this document, the terms in this document shall prevail.

Finally, it should be understood that the exemplary embodiments disclosed herein are illustrative of the principles of the embodiments of the disclosure. Other modified embodiments are also within the scope of this disclosure. Therefore, the exemplary embodiments disclosed in this disclosure are merely examples and are not limiting. A person skilled in the art may implement alternative configurations according to these exemplary embodiments in this disclosure to implement the present disclosure. Therefore, the embodiments of the present disclosure are not limited to those which have been precisely described in the present disclosure.

What is claimed is:

1. An autonomous driving system for updating a map, comprising:
an on-board electronic device, including:
at least one storage medium storing a set of instructions for updating a map, and
at least one processor in communication with the at least one storage medium, wherein during operation, the at least one processor executes the set of instructions to:
send, by a vehicle including the on-board electronic device, a local map request to a server, wherein the local map request includes current location data of the vehicle, and the vehicle includes an autonomous driving vehicle,
receive, by the vehicle, a first local map of a current location from the server, wherein the first local map covers a first distance on a route traveled by the vehicle,
collect, by a sensor mounted on the vehicle first surrounding environment data of the vehicle during driving along the first distance,
generate, by the vehicle, map update data based on the first local map and the first surrounding environment data, and
send, by the vehicle, the map update data to the server.

2. The autonomous driving system according to claim 1, wherein
the sensor includes at least one of a lidar, a millimeter wave radar, an ultrasonic radar, or a camera.

3. The autonomous driving system according to claim 1, the at least one processor further executes the set of instructions to:
collect, by the sensor, second surrounding environment data of the current location;
match, by the vehicle, the second surrounding environment data with the first local map; and
determine, by the vehicle, a type of the map update data based on a matching result.

4. The autonomous driving system according to claim 3, wherein
the first local map includes a landmark point set;
the second surrounding environment data includes a second feature point set; and
to match the second surrounding environment data with the first local map includes determine a ratio of feature points in the second feature point set that match landmark points in the landmark point set to all feature points in the second feature point set.

5. The autonomous driving system according to claim 4, wherein
the matching result includes that the ratio is greater than a first threshold;
the first surrounding environment data includes a first feature points set corresponding to data collected by the sensor within the first distance; and
the map update data includes feature points in the first feature point set that do not match any landmark point in the landmark point set.

6. The autonomous driving system according to claim 5, wherein
the map update data further includes landmark points in the landmark point set that match feature points in the first feature point set.

7. The autonomous driving system according to claim 6, wherein the at least one processor further executes the set of instructions to:
determine that the first local map includes the first distance and a second distance;
delete, by the vehicle, a portion of the first local map corresponding to the first distance after the vehicle sending the map update data to the server;
send, by the vehicle, a new local map request to the server; and
receive, by the vehicle, a second local map including the second distance and a third distance sent by the server.

8. The autonomous driving system according to claim 4, wherein
the matching result is that the ratio is less than a first threshold; and
the map update data includes a local map corresponding to the first distance generated by the vehicle based on the first surrounding environment data.

9. The autonomous driving system according to claim 1, wherein
the first local map includes a map generation instruction, which indicates that the first local map is not stored in the server, and the vehicle is required to generate the first local map.

10. A map updating system for autonomous driving, comprising:
a server, including:
at least one storage medium storing a set of instructions for updating a map, and
at least one processor in communication with the at least one storage medium, wherein during operation, the at least one processor executes the set of instructions to:
receive, by the server, a local map request sent by a vehicle, wherein the local map request includes current location data of the vehicle, and the vehicle includes an autonomous driving vehicle,
determine, by the server, a first local map from a global map based on the current location data,
send, by the server, the first local map to the vehicle, receive, by the server, map update data sent by the vehicle, and
update, by the server, a portion of the global map corresponding to the first local map based on the map update data.

11. The map updating system for autonomous driving according to claim 10, wherein
the global map is stored in a storage device of the server;
a storage granularity of the global map is data of a landmark point; and
the data of one landmark point includes three-dimensional space information, visual feature information, positioning effect information, and a group marker of the landmark point.

12. The map updating system for autonomous driving according to claim 10, wherein
the local map request further includes on-board electronic device performance data of the vehicle; and
to determine the first local map includes: determine, by the server, a size of the first local map based on the on-board electronic device performance data of the vehicle.

13. The method according to claim 9, wherein
the local map request further includes a driving direction of the vehicle; and
to determine the first local map includes: determine, by the server, the first local map based on the driving direction of the vehicle and current location data.

14. The map updating system for autonomous driving according to claim 10, wherein
the first local map includes a map generation instruction, which indicates that the first local map is not stored in the server; and
the map generation instruction includes requesting the vehicle to generate the first local map.

15. The method according to claim 10, wherein to update the portion of the updated global map corresponding to the first local map includes:
update, by the server, the portion of the global map corresponding to the first local map based on the map update data and update data corresponding to the first local map uploaded by at least one another vehicle.

16. A map updating method for autonomous driving, comprising:
sending, by a vehicle, a local map request to a server, wherein the local map request includes current location data of the vehicle, and the vehicle includes an autonomous driving vehicle;
receiving, by the vehicle, a first local map of a current location from the server, wherein the first local map covers a first distance on a route traveled by the vehicle;
collecting, by a sensor mounted on the vehicle, first surrounding environment data of the vehicle during driving along the first distance;
generating, by the vehicle, map update data based on the first local map and the first surrounding environment data; and
sending, by the vehicle, the map update data to the server.

17. The method according to claim 16, further comprising:
collecting, by the sensor, second surrounding environment data of the current location;
matching, by the vehicle, the second surrounding environment data with the first local map; and
determining, by the vehicle, a type of the map update data based on a matching result.

18. The method according to claim 17, wherein
the first local map includes a landmark point set;
the second surrounding environment data includes a second feature point set; and
the matching includes determining a ratio of feature points in the second feature point set that match landmark points in the landmark point set to all feature points in the second feature point set.

19. A map updating method for autonomous driving, comprising:
receiving, by a server, a local map request sent by a vehicle, wherein the local map request includes current location data of the vehicle, and the vehicle includes an autonomous driving vehicle;
determining, by the server, a first local map from a global map based on the current location data;
sending, by the server, the first local map to the vehicle;
receiving, by the server, map update data sent by the vehicle; and
updating, by the server, a portion of the global map corresponding to the first local map based on the map update data.

20. The method according to claim 19, wherein
the global map is stored in a storage device of the server;
a storage granularity of the global map is data of a landmark point; and
the data of one landmark point includes three-dimensional space information, visual feature information, positioning effect information, and a group marker of the landmark point.
